(19) United States
(12) Patent Application Publication
(10) Pub. No.: US 2026/0222355 A1
(43) Pub. Date: Jul. 30, 2026

(54) METHOD AND APPARATUS FOR CONGESTION HANDLING WHILE PACKET DISCARDING FOR EXTENDED REALITY IN A WIRELESS COMMUNICATION SYSTEM

(71) Applicant: Samsung Electronics Co., Ltd., Suwon-si, Gyeonggi-do (KR)

(72) Inventors: Vinay Kumar SHRIVASTAVA, Bangalore (IN); Sriganesh RAJENDRAN, Bangalore (IN)

(21) Appl. No.: 19/158,248

(22) PCT Filed: Mar. 21, 2024
(86) PCT No.: PCT/KR2024/095607

§ 371 Date: Aug. 20, 2025

(30) Foreign Application Priority Data
Mar. 31, 2023 (IN) 202341024770
Mar. 12, 2024 (IN) 202341024770

(51) Int. Cl. H04L 47/32; H04W 28/02

(52) U.S. Cl. CPC H04L 47/32; H04W 28/0289

(57) ABSTRACT

The disclosure relates to a 5G or 6G communication system for supporting a higher data transmission rate. Embodiments herein is to provide method for congestion handling while packet discarding for extended reality. UE (101) transmits UE capability message to network apparatus (201) for indicating support of PSI based SDU discard. Further, UE (101) receives signaling message from network apparatus (201) to be configured with discard information for congestion handling. Also, UE (101) receive SDU or PDU of PDU Set associated with PSI value from upper layer. Further, UE start first discard timer for low importance or second discard timer based on PSI value of PDU Set, when PSI based SDU discard status of corresponding DRB is activated. Also, UE discards PDU Set when first discard timer for low importance or second discard timer expires. Further, UE starts second discard timer when PSI based SDU discard status of corresponding DRB is deactivated and discards PDU Set upon expiry of second discard timer.

### TECHNICAL FIELD

The present disclosure is related to, a telecommunication network. More particularly the present disclosure is related to congestion handling while packet discarding for extended reality.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

This disclosure relates to wireless communication networks, and more particularly to a terminal and a communication method thereof in a wireless communication system.

In accordance with an aspect of the disclosure, the objectives are achieved by [9] providing a method for congestion handling while packet discarding for extended reality. The method includes transmitting, by a User Equipment (UE), a UE capability message to a network apparatus for indicating support of a PSI based SDU discard. Further, the method includes receiving, by the UE, a signaling message from the network to be configured with discard information for congestion handling. The discard information comprises at least one of an implicit congestion status or an explicit congestion status, a first discard timer for low importance, a second discard timer and a PSI based SDU discard status of one or more Data Radio Bearers (DRBs).

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates a UE for handling congestion while packet discarding for extended reality (XR), according to the embodiment as disclosed herein;

FIG. 2 is a block diagram that illustrates a network apparatus for handling congestion while packet discarding for extended reality (XR), according to the embodiment as disclosed herein;

FIG. 3 is a sequence diagram that illustrates a process of handling congestion by UE while packet discarding for extended reality (XR), according to the embodiment as disclosed herein;

FIG. 4 is a flow diagram illustrating a method of handling congestion by User equipment while packet discarding for extended reality (XR), according to the embodiment as disclosed herein;

FIG. 5 is a flow diagram illustrating a method of handling congestion by network apparatus while packet discarding for extended reality (XR), according to the embodiment as disclosed herein;

FIG. 6 illustrates various hardware components of a UE, according to the embodiments as disclosed herein; and

FIG. 7 illustrates various hardware components of a base station according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

In one aspect, the objectives are achieved by providing a method for congestion handling while packet discarding for extended reality. The method includes transmitting, by a User Equipment (UE), a UE capability message to a network apparatus for indicating support of a PSI based SDU discard. Further, the method includes receiving, by the UE, a signaling message from the network to be configured with discard information for congestion handling. The discard information comprises at least one of an implicit congestion status or an explicit congestion status, a first discard timer for low importance, a second discard timer and a PSI based SDU discard status of one or more Data Radio Bearers (DRBs). Further, the method includes receiving, by the UE, at least one SDU or at least one PDU of at least one PDU Set associated with a PSI value from a upper layer. The PSI value is one of a lower PSI value or a higher PSI value. Further, determining, by the UE, whether the PSI based SDU discard status of one or more DRBs is activated or deactivated. Further, starting the first discard timer for low importance associated with the at least one SDU or the at least one PDU of the at least one PDU Set associated with the higher PSI value, when the at least one SDU or the at least one PDU of the at least one PDU Set is received from the upper layer, and when the PSI based SDU discard status of the corresponding DRB is activated. Also, discarding at least one SDU or at least one PDU of at least one PDU Set associated with the lower PSI value, when the PSI based SDU discard status of corresponding DRB is activated, and when the first discard timer for low importance expires. Further, starting the second discard timer associated with the at least one SDU or the at least one PDU of the at least one PDU Set associated with the lower PSI value, when the at least one SDU or the at least one PDU of the at least one PDU Set is received from the upper layer and when the PSI based SDU discard status of the corresponding DRB is activated. Also, discarding at least one SDU or at least one PDU of at least one PDU Set associated with the higher PSI value, when the second discard timer expires. Further, starting the second discard timer associated with the at least one SDU or the at least one PDU of the at least one PDU Set irrespective of the higher PSI value or the lower PSI value, when the at least one SDU or the at least one PDU of the at least one PDU Set is received from the upper layer and, when the PSI based SDU discard status of the corresponding DRB is deactivated. Also discarding the at least one SDU or the at least one PDU of the at least one PDU Set irrespective of the higher PSI value or the lower PSI value, when the second discard timer expires.

In an embodiment, the discard information for congestion handling comprises a first discard timer for low importance, a second discard timer, a threshold of PDU Set Importance (PSI) value, a list of PSI value associated with at least one PDU Set, a list of Quality of Service (QoS) flows, and a list of Data Radio Bearers (DRBs) for which the PSI based SDU discard is applicable or configured.

In an embodiment, the UE capability message is at least one of a UE capability information message, an UE assistance information message, a RRC setup complete message and a RRC resume complete message.

In an embodiment, the signaling message is a Radio Resource Control (RRC) signaling message.

In an embodiment, the signaling message is a Medium Access Control (MAC) Control Element (CE) signaling message wherein at least PSI based SDU discard status is provided by the network to the UE as a PSI based SDU discard activation or deactivation indication for one or more DRBs in the MAC CE.

In an embodiment, the PSI based SDU discard status of the one or more DRBs is indicated in at least one of a bit, bitmap, a field, a code-point, a flag, an index or an information element.

In an embodiment, the PDU Set comprises at least one SDU or at least one PDU.

In an embodiment, the higher PSI value is associated to at least one of a low importance PDU Set and the lower PSI value is associated to at least one of high importance PDU Set.

In an embodiment, the method of discarding the at least one SDU or at least one PDU of the at least one PDU Set associated with lower PSI value includes starting, by the UE, the first discard timer for low importance of the at least one SDU or at least one PDU of the at least one PDU Set associated with higher PSI value, when the PSI based SDU discard status of the corresponding DRB is activated. Further the method includes discarding the at least one SDU or at least one PDU of the at least one PDU Set associated with higher PSI value, when the first discard timer for low importance expires.

In an embodiment, the method includes determining whether PSI based SDU discard status of the one or more DRBs is activated. Further, the method includes continuing the second discard timer and discarding the at least one SDU or at least one PDU of PDU Set associated with lower PSI values upon the expiry of the second discard timer, when the PSI based SDU discard is activated and when the second discard timer of the at least one PDU Set associated with lower PSI value is running.

In an embodiment, the method includes determining PSI based SDU discard is activated. Further, the method includes applying, by the UE, the first discard timer for low importance to the at least one SDU or the at least one PDU of the at least one PDU Set that arrives after the detection of the congestion, when the PSI based SDU discard status of the corresponding DRB is activated and when the second discard timer of the at least one SDU or the at least one PDU of the at least one PDU Set is running.

In an embodiment, the method includes continuing, by the UE, the first discard timer for low importance when the PSI based SDU discard status of the corresponding DRB is deactivated and the first discard timer for low importance of the at least one SDU or the at least one of PDU of the at least one PDU Set is still running.

In an embodiment, the method includes, detecting the at least one explicit congestion status or the implicit congestion status based on at least one of a buffer status threshold, delay threshold indicated in the signaling message, wherein the detection is at least one of per XR bearer, per XR service, per QoS flow or commonly for all XR bearer, XR service, QoS flows. Further, the method includes detecting the at least one explicit congestion status or the implicit congestion status when the number of SDUs or PDUs of the at least one PDU Set discarded upon the expiry of the second discard timer is greater than a preconfigured threshold number.

In an embodiment, the method includes receiving, by the UE, an indication of activation or deactivation of the PSI based SDU discard status of the one or more DRBs in the Medium Access Control (MAC) Control Element (CE) signalling message from the network apparatus, wherein the indication of activation or deactivation of the PSI based SDU discard status is provided in a MAC CE identified by MAC sub-header associated with a Logical Channel Identity (LCID). Further, the method includes determining, by the UE, the activation or deactivation of the PSI based SDU discard for pertinent DRBs to the upper layers, when the PSI based SDU discard status of the one or more DRBs is indicated to be activated or deactivated from the network apparatus.

In an embodiment, the activation or deactivation of the PSI based SDU discard status of the one or more DRBs is indicated using a bitmap field in the MAC CE, wherein the each bit of the bitmap field is set to at least one of lor 0 and is associated with a DRB configured for PSI based SDU discard.

In an embodiment, the PSI based SDU discard status of a DRB is determined to be activated when the associated bit in the bitmap field in the MAC CE is set to 1.

In an embodiment, the PSI based SDU discard status of a DRB is determined to be deactivated when the associated bit in the bitmap field in the MAC CE is set to 0.

In an embodiment, the method includes receiving, by the UE, an indication about the congestion in a cell for at least one of XR service, radio bearer, QoS flow in the MAC CE signaling message, wherein the MAC CE signaling message comprises a congestion status indication and is identified with a specific Logical Channel Identity (LCID). Further, the method includes receiving, by the UE, an indication about the congestion in the DCI message, wherein the DCI message comprises a congestion status indication field and is addressed by a specific RNTI.

In an embodiment, the method includes performing, by the UE, PSI based SDU discard when the at least one explicit congestion status or implicit congestion status is activated and until a change in the explicit congestion status or implicit congestion status is indicated or determined.

In an embodiment, the explicit congestion status is indicated explicitly by the network apparatus and the implicit congestion status is implicitly determined by the UE.

In an embodiment, the upper layer is at least one of an application layer, a Service Data Adaption Protocol (SDAP) layer and a service layer.

Accordingly, the embodiment herein is to provide a method for handling congestion while packet discarding for extended reality (XR). The method includes, receiving, by a network apparatus, a UE capability message from a UE about an indication to support of PSI based SDU discard. Further, the method includes transmitting, by the network apparatus, a signaling message to configure the UE with discard information for congestion handling. The discard information for congestion handling comprises an explicit congestion status or an implicit congestion status, a first discard timer for low importance, a second discard timer, and a PSI based SDU discard status for one or more Data Radio Bearers (DRBs). Further, the method includes receiving, by the network apparatus, at least one SDU or at least one PDU of the at least one PDU Set from the UE.

In an embodiment, the discard information for congestion handling comprises a first discard timer for low importance, a second discard timer, a threshold of PDU Set Importance (PSI) value, a list of PSI value associated with at least one PDU Set, a list of Quality of Service (QoS) flows, and a list of Data Radio Bearers (DRBs) for which the PSI based SDU discard is applicable or configured.

In an embodiment, the method includes transmitting, by the network apparatus, an indication of activation or deactivation of the PSI based SDU discard status of the one or more DRBs in the MAC CE signalling message to the UE, wherein the indication of activation or deactivation of the PSI based SDU discard status is provided in a MAC CE identified by a MAC sub-header associated with a Logical Channel Identity (LCID).

In an embodiment, the activation or deactivation of the PSI based SDU discard status of the one or more DRBs is indicated using a bitmap field in the MAC CE, wherein each bit of the bitmap field is set to at least one of 1 or 0 and is associated with a DRB configured for PSI based SDU discard.

In an embodiment, the PSI based SDU discard status of a DRB is determined to be activated when the associated bit in the bitmap field in the MAC CE is set to 1.

In an embodiment, the PSI based discard status of a DRB is determined to be deactivated when the associated bit in the bitmap field in the MAC CE is set to 0.

Accordingly, the embodiment herein is to provide a UE for handling congestion while packet discarding for extended reality (XR). The UE comprises a processor and a congestion manager. The congestion manager is configured to transmit a UE capability message to a network apparatus for indicating support of a PSI based SDU discard. Further, the congestion manager receives a signaling message from the network to be configured with discard information for congestion handling. The discard information comprises at least one of an implicit congestion status or an explicit congestion status, a first discard timer for low importance, a second discard timer and a PSI based SDU discard status of one or more Data Radio Bearers (DRBs). Further, the congestion manager receives at least one SDU or at least one PDU of at least one PDU Set associated with a PSI value from a upper layer. The PSI value is one of a lower PSI value or a higher PSI value. Further, the congestion manager determines whether the PSI based SDU discard status of one or more DRBs is activated or deactivated. Also, the method includes start the first discard timer for low importance associated with the at least one SDU or the at least one PDU of the at least one PDU Set associated with the higher PSI value, when the at least one SDU or the at least one PDU of the at least one PDU Set is received from the upper layer, and when the PSI based SDU discard status of the corresponding DRB is activated; and discard at least one SDU or at least one PDU of at least one PDU Set associated with the lower PSI value, when the PSI based SDU discard status of corresponding DRB is activated, when the first discard timer for low importance expires. Further, the congestion manager starts second discard timer associated with the at least one SDU or the at least one PDU of the at least one PDU Set associated with the lower PSI value, when the at least one SDU or the at least one PDU of the at least one PDU Set is received from the upper layer and when the PSI based SDU discard status of the corresponding DRB is activated. Also, discard at least one SDU or at least one PDU of at least one PDU Set associated with the higher PSI value, when the second discard timer expires. Further, the congestion manager starts the second discard timer associated with the at least one SDU or the at least one PDU of the at least one PDU Set irrespective of the higher PSI value or the lower PSI value when the at least one SDU or the at least one PDU of the at least one PDU Set is received from the upper layer and when the PSI based SDU discard status of the corresponding DRB is deactivated. Also, discard the at least one SDU or the at least one PDU of the at least one PDU Set irrespective of the higher PSI value or the lower PSI value, when the second discard timer expires.

Accordingly, the embodiment herein is to provide a network apparatus for handling congestion while packet discarding for extended reality (XR). The network apparatus comprises a processor and a congestion manager. The congestion manager receives a UE capability message from a UE about an indication to support of PSI based SDU discard. Further, the congestion manager transmits a signaling message to configure the UE with discard information for congestion handling, wherein the discard information for congestion handling comprises an explicit congestion status or an implicit congestion status, a first discard timer for low importance, a second discard timer, and a PSI based SDU discard status for one or more Data Radio Bearers (DRBs). Further, the congestion manager receives at least one SDU or at least one PDU of the at least one PDU Set from the UE.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

An Extended Reality (XR) is an umbrella term for different realities including Virtual Reality (VR), Augmented Reality (AR) and Mixed Reality (MR), and is considered as an essential technology to enable the realization of digital twin/meta universe. The XR is incorporated as an agreed work item in 5G Advanced (i.e. 3GPP Release 18), which is targeted to provide a communication system framework that fulfills challenging needs of high data rate, very low latency and power efficient connectivity for XR applications. Thus, it is desired to address the above mentioned disadvantages or other shortcomings or at least provide a useful alternative.

A Protocol Data Convergence Protocol (PDCP) is a layer-2 sub-layer and is involved in a number of functionalities for the data plane processing of the transmitted and received packets. The functionalities include but not limited to Service Data Unit (SDU) discard, ciphering and integrity protection, header compression on transmitting side and reordering, deciphering and integrity verification, duplicate discarding, header decompression on receiving side. Each radio bearer (RB) is associated with a transmitting PDCP entity and/or a receiving PDCP entity. The SDU discard procedure involves discard of the PDCP SDU when the associated timer is expired or the successful delivery of a PDCP SDU is confirmed from peer PDCP entity for example through a PDCP status report.

For the XR applications, the existing PDCP SDU discard is not efficient and effective as the XR applications are more tightly coupled with the frame or PDU Set transmission, and not with the IP packet transmission that is typically one-to-one mapped to the PDCP SDU. As a result, existing mechanism leads to an in-efficient SDU discard operation, excessive processing burden and/or transmission resource wastage and so on. Moreover, there may be a congestion situation at a network and needs to be addressed while discarding packets at a User Equipment (UE) and/or the network. Further, not all SDUs, or not all PDU Sets are of equal importance for the communication and discard operation during congestion situation.

Thus, it is desired to address the above mentioned disadvantages or other shortcomings or at least provide a useful alternative.

### OBJECT OF INVENTION

The principal object of the embodiments herein is to provide a method, user equipment and network apparatus for congestion handling while packet discarding for extended reality.

Yet another object of the embodiments herein is to provide a configuration signalling of PDU Set Importance (PSI) based discard parameters per radio bearer.

Another object of the embodiments herein is to provide an activation/deactivation mechanism including Medium Access Control (MAC) Control Element (CE) signalling, format and procedure.

Another object of the embodiments herein is to perform PDCP operations for PSI based SDU discard including multiple timers configuration and operation.

Another object of the embodiments herein is to provide an efficient approach for congestion handling and PSI based SDU discard mechanism for XR.

Another object of the embodiments herein is to improve the performance of the UE and network apparatus for XR applications.

Accordingly, the embodiments discloses a method for handling congestion while packet discarding for extended reality (XR). The method includes transmitting, by a User Equipment (UE), a UE capability message to a network apparatus for indicating support of a PSI based SDU discard. Further, the method includes receiving a signaling message from the network to be configured with discard information for congestion handling. The discard information comprises at least one of an implicit congestion status or an explicit congestion status, a first discard timer for low importance, a second discard timer and a PSI based SDU discard status of one or more Data Radio Bearers (DRBs). Further, the method includes receiving at least one SDU or at least one PDU of at least one PDU Set associated with a PSI value from a upper layer. The PSI value is one of a lower PSI value or a higher PSI value. Further, determining whether the PSI based SDU discard status of one or more DRBs is activated or deactivated. Further, starting the first discard timer for low importance associated with the at least one SDU or the at least one PDU of the at least one PDU Set associated with the higher PSI value, when the at least one SDU or the at least one PDU of the at least one PDU Set is received from the upper layer, and when the PSI based SDU discard status of the corresponding DRB is activated. Also, discarding at least one SDU or at least one PDU of at least one PDU Set associated with the lower PSI value, when the PSI based SDU discard status of corresponding DRB is activated, when the first discard timer for low importance expires. Further, starting second discard timer associated with the at least one SDU or the at least one PDU of the at least one PDU Set associated with the lower PSI value, when the at least one SDU or the at least one PDU of the at least one PDU Set is received from the upper layer and when the PSI based SDU discard status of the corresponding DRB is activated. Also, discarding at least one SDU or at least one PDU of at least one PDU Set associated with the higher PSI value, when the second discard timer expires. Further, starting the second discard timer associated with the at least one SDU or the at least one PDU of the at least one PDU Set irrespective of the higher PSI value or the lower PSI value when the at least one SDU or the at least one PDU of the at least one PDU Set is received from the upper layer and when the PSI based SDU discard status of the corresponding DRB is deactivated. Also discarding the at least one SDU or the at least one PDU of the at least one PDU Set irrespective of the higher PSI value or the lower PSI value, when the second discard timer expires.

Accordingly, the embodiments discloses a method for handling congestion while packet discarding for extended reality (XR). The method includes receiving a UE capability message from a UE about an indication to support of PSI based SDU discard. Further, the method includes transmitting, by the network apparatus, a signaling message to configure the UE with discard information for congestion handling. The discard information for congestion handling comprises an explicit congestion status or an implicit congestion status, a first discard timer for low importance, a second discard timer, and a PSI based SDU discard status for one or more Data Radio Bearers (DRBs). Further, the method includes receiving at least one SDU or at least one PDU of the at least one PDU Set from the UE.

Accordingly, the embodiments discloses a UE for handling congestion while packet discarding for extended reality (XR). The UE comprises a processor and a congestion manager. The congestion manager is configured to transmit a UE capability message to a network apparatus for indicating support of a PSI based SDU discard. Further, the congestion manager receives a signaling message from the network to be configured with discard information for congestion handling. The discard information comprises at least one of an implicit congestion status or an explicit congestion status, a first discard timer for low importance, a second discard timer and a PSI based SDU discard status of one or more Data Radio Bearers (DRBs). Further, the congestion manager receives at least one SDU or at least one PDU of at least one PDU Set associated with a PSI value from a upper layer. The PSI value is one of a lower PSI value or a higher PSI value. Further, the congestion manager determines whether the PSI based SDU discard status of one or more DRBs is activated or deactivated. Also, the method includes start the first discard timer for low importance associated with the at least one SDU or the at least one PDU of the at least one PDU Set associated with the higher PSI value, when the at least one SDU or the at least one PDU of the at least one PDU Set is received from the upper layer, and when the PSI based SDU discard status of the corresponding DRB is activated; and discard at least one SDU or at least one PDU of at least one PDU Set associated with the lower PSI value, when the PSI based SDU discard status of corresponding DRB is activated, when the first discard timer for low importance expires. Further, the congestion manager starts second discard timer associated with the at least one SDU or the at least one PDU of the at least one PDU Set associated with the lower PSI value, when the at least one SDU or the at least one PDU of the at least one PDU Set is received from the upper layer and when the PSI based SDU discard status of the corresponding DRB is activated. Also, discard at least one SDU or at least one PDU of at least one PDU Set associated with the higher PSI value, when the second discard timer expires. Further, the congestion manager starts the second discard timer associated with the at least one SDU or the at least one PDU of the at least one PDU Set irrespective of the higher PSI value or the lower PSI value when the at least one SDU or the at least one PDU of the at least one PDU Set is received from the upper layer and when the PSI based SDU discard status of the corresponding DRB is deactivated. Also, discard the at least one SDU or the at least one PDU of the at least one PDU Set irrespective of the higher PSI value or the lower PSI value, when the second discard timer expires.

Accordingly, the embodiments discloses a network apparatus for handling congestion while packet discarding for extended reality (XR). The network apparatus comprises a processor and a congestion manager. The congestion manager receives a UE capability message from a UE about an indication to support of PSI based SDU discard. Further, the congestion manager transmits a signaling message to configure the UE with discard information for congestion handling, wherein the discard information for congestion handling comprises an explicit congestion status or an implicit congestion status, a first discard timer for low importance, a second discard timer, and a PSI based SDU discard status for one or more Data Radio Bearers (DRBs). Further, the congestion manager receives at least one SDU or at least one PDU of the at least one PDU Set from the UE.

Thus, the proposed solution enables an efficient approach for congestion handling and PSI based discard mechanism for XR. Further, the proposed solution enhances the UE and network performance for XR applications.

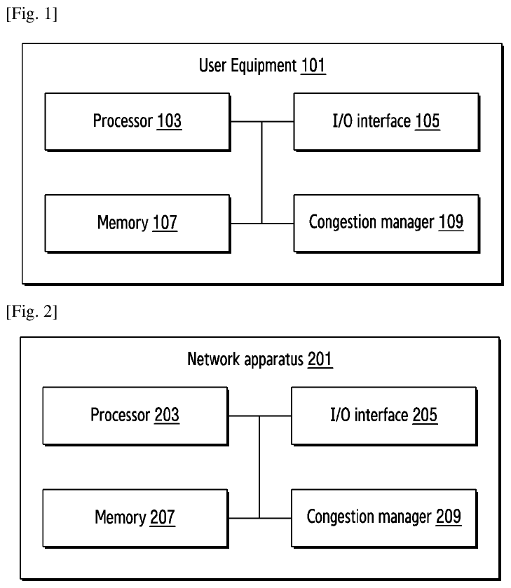

FIG. 1 is a block diagram that illustrates a UE for handling congestion while packet discarding for extended reality (XR), according to the embodiment as disclosed herein. The UE ((101) comprises a suite of components, including a processor (103), an I/O interface (105), a memory (107), and a congestion manager (109). This device serves as a conduit for end-users to connect with communication networks and access various services. The UE (101) can take on many forms, including but not limited to mobile phones, smartphones, tablets, laptops, television, connected cars and Internet of Things (IoT) devices. However, the components of the UE (101) are not limited thereto. For example, the UE (101) may include more or fewer components than those described above. In addition, the UE (101) corresponds to the UE of the FIG. 6.

The processor (103) of the UE (101) communicates with the memory (107), I/O interface (105), and the congestion manager (109), executing instructions stored in the memory (107) and performing various processes. It may consist of one or multiple processors, such as a general-purpose CPU, an AP, a GPU, a VPU, and/or an AIdedicated NPU.

Further, the memory (107) of the UE (101) includes storage locations to be addressable through the processor (103). The memory (107) can store at least one of a congestion manager information received from the network apparatus, at least one SDU or PDU of the at least one PDU Set, PSI value from upper layer of the UE (101). The memory (107) is not limited to a volatile memory and/or a non-volatile memory. Further, the memory (107) can include one or more computer-readable storage media. The memory (107) can include non-volatile storage elements. For example, nonvolatile storage elements can include magnetic hard discs, optical discs, floppy discs, flash memories, or forms of electrically programmable memories (EPROM) or electrically erasable and programmable (EEPROM) memories. The memory (107) can store the media streams such as audios stream, video streams, haptic feedbacks and the like.

The I/O interface (105) transmits the information between the memory (107) and external peripheral devices. The peripheral devices are the input-output devices associated with the UE (101). The UE (101) receives configuration messages from the network apparatus and transmits the UE capability message to the network apparatus through the I/O interface (105).

The congestion manager (109) of the UE (101) communicates with the I/O interface (105) and memory (107) for handling congestion while packet discarding for extended reality (XR). The congestion manager (109) is an innovative hardware that is realized through the physical implementation of both analog and digital circuits, including logic gates, integrated circuits, microprocessors, microcontrollers, memory circuits, passive and active electronic components, as well as optical components.

The congestion manager (109) transmits a UE capability message to the network apparatus for indicating support of a PSI based SDU discard. Further, the congestion manager (109) receives a signaling message from the network apparatus to be configured with discard information for congestion handling. The discard information comprises at least one of an implicit congestion status or an explicit congestion status, a first discard timer for low importance, a second discard timer and a PSI based SDU discard status of one or more Data Radio Bearers (DRBs). The implicit congestion status is determined by the UE (101). Also, the explicit congestion status is explicitly indicated by the network apparatus.

Further, the congestion manager (109) receives at least one SDU or at least one PDU of at least one PDU Set associated with a PSI value from a upper layer, wherein the PSI value is one of a lower PSI value or a higher PSI value. Also, the congestion manager (109) determines whether the PSI based SDU discard status of one or more DRBs is activated or deactivated. Further, the congestion manager (109) starts the first discard timer for low importance associated with the at least one SDU or the at least one PDU of the at least one PDU Set associated with the higher PSI value, when the at least one SDU or the at least one PDU of the at least one PDU Set is received from the upper layer, and when the PSI based SDU discard status of the corresponding DRB is activated. Further, the congestion manager (109) discards at least one SDU or at least one PDU of at least one PDU Set associated with the lower PSI value, when the PSI based SDU discard status of corresponding DRB is activated, when the first discard timer for low importance expires.

Also, the congestion manager (109) starts second discard timer associated with the at least one SDU or the at least one PDU of the at least one PDU Set associated with the lower PSI value, when the at least one SDU or the at least one PDU of the at least one PDU Set is received from the upper layer and when the PSI based SDU discard status of the corresponding DRB is activated. Further the congestion manager (109) discards at least one SDU or at least one PDU of at least one PDU Set associated with the higher PSI value, when the second discard timer expires.

Further, the congestion manager (109) starts the second discard timer associated with the at least one SDU or the at least one PDU of the at least one PDU Set irrespective of the higher PSI value or the lower PSI value when the at least one SDU or the at least one PDU of the at least one PDU Set is received from the upper layer and when the PSI based SDU discard status of the corresponding DRB is deactivated. Also, discards the at least one SDU or the at least one PDU of the at least one PDU Set irrespective of the higher PSI value or the lower PSI value, when the second discard timer expires.

The signaling message is a MAC CE signaling message, Further, the PSI based SDU discard activation or deactivation indication for one or more DRBs is provided in the MAC CE signaling message.

Also, the congestion manager (109) receives an indication of the activation or deactivation of the PSI based discard status of the one or more DRBs in the MAC CE signaling message from the network apparatus. The indication of the activation or deactivation of the PSI based SDU discard status is provided in the MAC CE identified by MAC-sub header that is associated with LCID. The indication of activation or deactivation can be provided in the form of a bitmap field in the MAC CE. The bit map field can be set to at least one of 0 or 1. The bitmap field is set as 1, when the PSI based SDU discard status is determined to be activated. Similarly, when the bitmap field is set as 0 when the PSI based SDU discard status is determined to be deactivated.

In an embodiment, the UE (101) indicates capability to support congestion based discard mechanism and/or PSI based discard mechanism to support the network in at least one of a UE capability information message, an UE assistance information message, a RRC Setup complete and a RRC Resume Complete message.

In an embodiment, the UE (101) is configured with a congestion manager information by the network apparatus (201) in the RRC signaling message (e.g. a RRC reconfiguration message). The congestion manager information can be for at least one of a specific XR service or a specific XR radio bearer or a specific, XR QoS flow or collectively for all the XR services, XR radio bearer or XR QoS flows. The congestion manager information can include at least one of a congestion timer (interchangeably used as first discard timer for low importance/second discard timer), a threshold of the PSI value (e.g. below which the congestion based discard handling is applicable), a list of PSI values (for the congestion based discard handling that is applicable and/or for the congestion based discard handling that is not applicable), a list of applicable QoS flows or DRBs to which the congestion based discard handling is applicable. A list of discard timers pertaining to different values of the PSI values for the relevant DRB(s), a set of triggers or thresholds for congestion manager by the UE (101) (e.g. a threshold for number of PDUs/SDUs or PDU Sets or data bytes to be discarded upon determination or indication of the congestion). These triggers or thresholds may be per DRB and can comprise of, for example, an amount of buffered data in second layer buffers or a specific value of Buffer Status Report (BSR) and/or an associated duration for accumulated buffer status, and a delay threshold for delay the UE (101) is experiencing for the transmission of the data or a threshold for a uplink grant allocation.

In an embodiment, the PDCP entity of the UE (101) is configured with multiple discard timer values for different PSI values for the PDU Sets and transmitting the PDCP entity starts the respective timer with the appropriate discard timer value based on the PSI of the PDU Set received from the higher layer and is associated with.

In an embodiment, a different value of the discard timer for the PDU Set(s) associated with the different PSI value(s) is only used when congestion status is activated (i.e. when UE detects or determines congestion and/or UE is indicated or signaled congestion by network). When congestion status is not activated or is deactivated (UE detects/determines no congestion situation and/or UE is indicated/signaled no congestion situation by network), all PDU Sets irrespective of the associated PSI value(s) can use same value (a single common value or a default value) of the discard timer.

In an embodiment, when congestion status is activated and already a discard timer running for PDU Set(s) with lower PSI value(s) than a configured threshold PSI, the discard timer, is stopped and the PDU Set(s) with lower PSI value(s) is discarded.

In an embodiment, when congestion status is activated and already a discard timer running for PDU Set(s) with higher PSI values (PDU set having higher PSI value can be interchangeably used PDU set with low importance than a configured threshold PSI, the discard timer is continued running. The PDU Set(s) with higher PSI value(s) may be discarded, only upon the discard timer expiry.

In an embodiment, only one value of discard timer is configured for the PDU Set(s) with lower importance (i.e. lower PSI value) and the PDU Set(s) with higher importance (i.e. higher PSI values), however, when the discard timer is expired for the PDU Set with lower PSI, the SDUs of the respective PDU Set are discarded. When the discard timer is expired for the PDU Set with higher PSI value, the SDU of the PDU Set are not discarded and are considered for transmission, given their higher importance.

In an embodiment, the UE (101) is configured with and/or utilizes a single timer (e.g. first discardTimer for low importance) for a PDU Set when the relevant QoS flow or the DRB is configured with a PDU Set Integrated Handling Indication (PSIHI) set as TRUE. Otherwise, when the PSIHI for the QoS flow or the DRB is set as FALSE, the UE (101) is configured with and/or utilizes a legacy timer (e.g. discardTimer) for each SDU of the PDU Set for the relevant QoS flow. The upper layer can indicate the PSIHI for the QoS flow to the PDCP entity associated with the QoS flow.

In an embodiment the second discard timer (used for per SDU discard) when configured for the XR radio bearers acts as first discard Timer for low importance (hereinafter first discard timer for low importance is interchangeably used as PSI based discard timer). In an embodiment the second discard timer acts as a PDU Set based discard timer rather than SDU discard timer for XR radio bearers. In an embodiment, one or more values for second discard timer are configured for different values of the PSI for the PDU Sets.

In an embodiment, upon detecting/determining a congestion situation and/or when indicated/signaled about the congestion situation by network, the PDCP entity modifies the discard timer value for the SDUs of the PDU Set which are already in buffer based on the PSI specific discard timer value. Wherein, the discard timer can be per SDU or per PDU Set.

In an embodiment, upon detecting/determining a congestion situation and/or when indicated/signaled about the congestion situation by network, the PDCP entity does not apply the PSI based discard timer values for SDUs of the PDU Set which already have a running discard timer. The PDCP entity applies the PSI based discard timer values only to those SDUs which arrive after the congestion is detected. Wherein, the discard timer can be per SDU or per PDU Set.

In an embodiment, upon detecting/determining a congestion situation is over and/or when indicated/signaled about the congestion situation is over by network, the PDCP entity modifies the discard timer value for the SDUs of the PDU Set which are already in buffer based on the configured discard timer value (i.e. not based on PSI specific discard timer value). Wherein, the discard timer can be per SDU or per PDU Set.

In an embodiment, upon detecting/determining a congestion situation is over and/or when indicated/signaled about the congestion situation is over by network, the PDCP entity does not modify the PSI based discard timer values for SDUs of the PDU Set which already have a running discard timer (i.e. not PSI based discard timer). The PDCP entity applies the configured discard timer value (i.e. not based on PSI specific discard timer value) only to those SDUs which arrive after the congestion is detected.

Wherein, the discard timer can be per SDU or per PDU Set.

In an embodiment, if the PSI based discard timer(s) is running and there is a change in congestion status detection/determination and/or indication/signaling by network, the PDCP entity stops/resets the running discard timer(s) for all PDCP SDUs of the PDU Set and/or stops/resets the running discard timers for PDU Set in the buffer.

In an embodiment, if the PSI based discard timer(s) is running and there is a change in congestion status detection/determination and/or indication/signaling by network (e.g. congestion is over or PSI based SDU discard is dectivated), the PDCP entity does not stop the PSI based discard timer(s) for all PDCP SDUs of the PDU Set and/or does not stop the PSI based discard timer for the PDU Set in the buffer. That is, the PSI based discard timer(s) are continued. The discard timer values are applied to the newly arrived SDUs of the PDU Set or the PDU Set.

In an embodiment, if the discard timer(s) (i.e. not PSI based discard timer(s)) is running and there is a change in congestion status detection/determination and/or indication/signaling by network (e.g. congestion is active or PSI based SDU discard is activated), the PDCP entity does not stop the discard timer(s) for all PDCP SDUs of the PDU Set and/or does not stop the discard timer(s) (i.e. not PSI based discard timer) for the PDU Set in the buffer. That is, the discard timer(s) are continued. The PSI based discard timer values are applied to the newly arrived SDUs of the PDU Set or the PDU Set.

In an embodiment, the UE (101) autonomously detects congestion and/or determines congestion based on configurations provided by the network such as buffer status thresholds, delay threshold etc. The detection and/or determination of the congestion can be per XR bearer/service/QoS flow or commonly for all XR bearers/services/QoS flows.

In an embodiment, the UE (101) detects congestion based on a configured threshold for number of XR PDCP SDUs/PDUs discarded due to expiry of legacy discard timer. The threshold can be configured per XR bearer/service/QoS Flow. When the number of discarded PDCP PDUs cross the configured threshold, the UE (101) triggers procedures associated with congestion based discard to alleviate congestion.

A sample specification text describing the procedure to detect congestion based on maximum number of PDUs discarded via legacy discard procedure is shown below:
When the discardTimer expires,
If PDCP entity is associated with an XR RB and XRcondForCongestion is configured with legacyDiscardThreshold option,
If discardDetectionTImer is not running,
Start discardDetectionTImer
If discardDetectionTImer is running
Increment numLegacyDiscard state variable
If numLegacyDiscard state variable>=numLegacyDiscardThreshold
Consider congestion scenario has occurred, initiate congestion based discard procedure
If discardDetectionTImer expires,
Reset numLegacyDiscard state variable to 0

In an embodiment, the UE (101) is indicated about congestion in the cell and/or for at least one of the XR service or the radio bearer or the QoS flow or for the UE (101), by the network through one of dedicated signaling methods like downlink control indication (DCI) based signaling and/or Medium Access Control (MAC) Control element (CE) based signaling and/or RRC based signaling, or through use of common signaling as part broadcasted System Information Message (e.g. an existing SIB or a new SIB) and/or group based signaling. The indication for the congestion can be through at least one of a bit, bitmap, a field, a code-point, a flag, an index or an information element. In an embodiment, the direction for the congestion may also be indicated e.g. downlink direction, uplink direction or both directions.

In an embodiment, a new MAC CE is defined for congestion status indication (e.g. termed as Congestion Status Indication MAC CE) and is addressed by a specific logical channel identity (LCID) field in the MAC header. The MAC CE may consist of one or more of a bit, a bitmap, a code-point, a flag or a field to indicate the congestion status (e.g. congestion is applicable or not applicable). The congestion indication may pertain to at least one of a XR bearer/service/QoS flow and/or a direction.

In an embodiment, a DCI is used or reused for congestion status indication (e.g. termed as Congestion Status Indication field) and is addressed by a specific RNTI. The DCI may be at least one of a scheduling DCI, a dedicated DCI or a common DCI. The DCI may consist of one or more of a bit, a bitmap, a code-point, a flag or a field to indicate the congestion status (e.g. congestion is applicable or not applicable). The congestion indication may pertain to at least one of a XR bearer/service/QoS flow and/or a direction.

In an embodiment, the UE (101) upon detection and/or indication of congestion, uses the PSI based discard mechanism until UE detects the change in congestion status and/or upon indication about the congestion status from the network.

In an alternate embodiment, the UE (101) is configured with a congestion timer by the network and/or an implementation specific congestion timer value is considered. The congestion timer is started at the UE upon detection of congestion or indication of congestion. The UE (101) applies PSI based discard mechanism until the running congestion timer expires. The congestion timer can be configured/implemented per XR service/bearer/QoS flow and/or common to all XR services/bearers/QoS flows transmitted/received in the UE (101).

In an embodiment, the UE (101) upon detection and/or indication of congestion in a specific service/bearer/QoS Flow, applies the PSI based discard only for the specific service/bearer/QoS flow which is experiencing congestion. Alternatively, the UE (101) applies the congestion based discard for all the XR services/bearers/QoS flows configured to the UE (101).

In an embodiment, a PSI value for the PDU Set is utilized irrespective of the congestion status (i.e. regardless of whether the UE (101) determines a congestion situation or not, or regardless of whether the UE (101) is informed or signaled by the network or not for a congestion situation).

In an embodiment, when a PDU belonging to a PDU Set with a higher value of PSI, pertaining to a DRB for which PSIHI is configured as TRUE and the congestion status is TRUE, for which discard timer is expired at PDCP and if one or more other PDCP PDUs belonging to that same PDU Set was submitted to RLC, PDCP may not indicate to RLC to discard the PDUs belonging to that PDU Set.

In an embodiment, when a PDU belonging to a PDU Set with a lower value of PSI, pertaining to a DRB for which PSIHI is configured as TRUE and the congestion status is TRUE, for which discard timer is expired at PDCP and if one or more other PDCP PDUs belonging to that same PDU Set was submitted to RLC, PDCP may indicate to RLC to discard the PDUs belonging to that PDU Set.

In an embodiment, the UE (101) maintains the congestion state that is set (i.e. “congestion” state) when the UE (101) detects/determines the congestion and/or is indicated/signaled for the congestion status by the network and which is reset (i.e. “no congestion” state) when the UE (101) no longer detects/determines the congestion and/or is indicated/signaled for the congestion is over by the network apparatus and/or relevant congestion timer has expired. The congestion state may be maintained for per service/bearer/QoS flow or for all the XR services/bearers/QoS flows configured to the UE (101). The default congestion state is “no congestion” state.

In an embodiment, the PDCP entity of the UE (101) indicates the congestion status (or congestion state) and/or PSIHI (also represented by PDU Set Discard parameter) and/or relevant PSI values and/or PSI threshold to the lower layer(s) (e.g. RLC layer, MAC layer) when the UE (101) detects/determines the congestion and/or is indicated/signaled for the congestion status by the network. Accordingly, the RLC layer performs the discard of the RLC SDUs and/or RLC PDUs (of the PDU Set) that pertain to the lower PSI values (i.e. below indicated threshold PSI value). Accordingly, the MAC layer perform logical channel prioritization i.e. de-prioritize or does not schedule the logical channel or the buffered L2 data or the PDU Sets that pertain to the lower PSI values (i.e. below indicated threshold PSI value).

In an embodiment, the PDCP entity of the UE (101) indicates that congestion is removed to the lower layer(s) (e.g. RLC layer, MAC layer) when the UE (101) no longer detects/determines the congestion and/or is indicated/signaled for the congestion is over by the network and/or relevant congestion timer has expired.

In an embodiment, receiving PDCP entity may be configured to deliver to upper layer without waiting for reordering timer to expire, if the UE (101) is detects/determines the congestion and/or is UE (101) is indicated/signaled for the congestion in the downlink direction.

In an embodiment, the configurations for XR bearers are carried in RRCReconfiguration message as part of PDCP configuration or separately as part of XRBearerConfigurations.

The following is the sample ASN structure of PDCPConfig containing XR Bearer related PDCP layer configurations:

```
  PDCP-Config::= SEQUENCE {
  drb SEQUENCE {
  discardTimer ENUMERATED {ms10, ms20, ms30, ms40, ms50, ms60,
  ms75, ms100, ms150, ms200, 5 ms250, ms300, ms500, ms750,
  ms1500, infinity} OPTIONAL, -- Cond Setup
  PSIdiscardThreshold INTEGER(0...maxPSI)
  XRcondForCongestion CHOCIE
  {
  legacyDiscardThreshold SEQUENCE{
    numlegacyDiscardThreshold
  INTEGER(1...maxDiscardThreshold),
  discardDetectionWindow ENUMERATED (ms10, ms20, ,,,infinity) },
  pdcpBufferDelayThreshold ENUMERATED (ms10, ms20, ms30 15 ...),
  pdcpBufferSizeThreshold ENUMERATED {kb1, kb2, kb4, ...} }
  OPTIONAL,
  PSIdiscardTimerList SEQUENCE (SIZE(1...maxPSI)) OF
  PSIdiscardTimer OPTIONAL,
  XRCongestionTimer ENUMERATED {ms0dot5, ms1, ms2, ms4, ms6,
  ms8, ms10, ms20, ms30, ms40, ms50, ms60, ms75, ms100, ms150,
  ms200,ms250, ms300, ms500, ms750, ms1500, infinity} OPTIONAL,
  XRDiscardThresholdBytes ENUMERATED {kb1, kb2, kb4, ...} 25
  OPTIONAL,
  XRDiscardThresholdPdus ENUMERATED {p0, p1, p2, ...}
  XRDiscardThresholdPduSets ENUMERATED {p0, p1, p2, ...}
      OPTIONAL,
  pdcp-SN-SizeUL ENUMERATED {len12bits, len18bits}
      OPTIONAL, -- Cond Setup1
  pdcp-SN-SizeDL ENUMERATED {len12bits, len18bits}
      OPTIONAL, -- Cond Setup2
    headerCompression CHOICE {
  notUsed NULL,
  rohc SEQUENCE {
  maxCID INTEGER (1..16383)
  DEFAULT 15,
      profiles SEQUENCE {
      profile0x0001 BOOLEAN,
      profile0x0002 BOOLEAN,
      profile0x0003 BOOLEAN,
      profile0x0004 BOOLEAN,
      profile0x0006 BOOLEAN,
      profile0x0101 BOOLEAN,
      profile0x0102 BOOLEAN,
      profile0x0103 BOOLEAN,
      profile0x0104 BOOLEAN
  },
  drb-ContinueROHC ENUMERATED { true }
      OPTIONAL -- Need N
  },
  uplinkOnlyROHC SEQUENCE {
    maxCID INTEGER (1..16383)
  DEFAULT 15,
      profiles SEQUENCE {
        profile0x0006 BOOLEAN },
    drb-ContinueROHC ENUMERATED { true }
      OPTIONAL -- Need N },
    ... 5 },
  integrityProtection ENUMERATED { enabled }
      OPTIONAL, -- Cond ConnectedToGC1
  statusReportRequired ENUMERATED { true }
      OPTIONAL, -- Cond Rlc-AM-UM
  outOfOrderDelivery ENUMERATED { true }
      OPTIONAL -- Need R }
OPTIONAL, -- Cond DRB
t-ReorderingXR ENUMERATED { 15 ms0, ms1, ms2, ms4, ms5, ms8,
ms10, ms15, ms20, ms30, ms40,ms50, ms60, ms80, ms100, ms120,
ms140, ms160, ms180, ms200, ms220,ms240, ms260, ms280, ms300,
ms500, ms750, ms1000, ms1250,ms1500, ms1750, ms2000, ms2250,
ms2500, ms2750,ms3000, spare28, spare27, spare26, 20 spare25,
spare24,spare23, spare22, spare21, spare20, spare19, spare18, spare17,
spare16, spare15, spare14, spare13, spare12, spare11, spare10, spare09,
spare08, spare07, spare06, spare05, spare04, spare03, spare02, spare01 }
OPTIONAL, -- Need S 25
  [[
survivalTimeStateSupport-r17 ENUMERATED {true}
OPTIONAL, -- Cond Drb-Duplication
  uplinkDataCompression-r17 SetupRelease
{ UplinkDataCompression-r17 } OPTIONAL, --
Cond Rlc-AM
  discardTimerExt2-r17 SetupRelease { DiscardTimerExt2- r17 }
OPTIONAL, -- Need N
multicastHFN-AndRefSN-r17 BIT STRING (SIZE (32))
OPTIONAL -- Cond SetupOnlyMRB 5 ]], }
PSIdiscardTimer SEQUENCE ::=
{
PSIList SEQUENCE( SIZE (1...maxPSI)) OF PSI,
XRdiscardTimer ENUMERATED {ms0dot5, ms1, ms2, ms4, ms6, ms8,
ms10, ms20, ms30, ms40, ms50, ms60, ms75, ms100, ms150,
ms200,ms250, ms300, ms500, ms750, ms1500, infinity}
OPTIONAL, -- Cond Setup
}
PSI INTEGER (1...maxPSI).
```

PSIdiscardThreshold: The PDUs belonging to PDU Sets having PSI value below the configured PSIdiscardThreshold value are considered for discard during the congestion based discard procedure.

XRDiscardThresholdPdus: Number of PDUs to be discarded when congestion based discard is activated and is ongoing.

XRDiscardThresholdPduSets: Number of PDU Sets to be discarded when congestion based discard is activated and is ongoing.

XRDiscardThresholdBytes: Total number of Bytes to be discarded when congestion based discard is activated and is ongoing. Kb1 indicates 1 kilobyte of data, kb2 indicates 2 kilobytes of data and so on

XRCongestionTimer: Timer which is started when congestion is detected and when running, the PSI based discard is performed at PDCP. Upon expiry, the PSI based discard is deactivated.

PSIDiscardTimer: Provides the timer value to be used for the PDUs associated with the PDU Sets having PSI value listed as part of the PSIList
XRcondForCongestion: Provides the condition for detecting congestion at the UE side. This can be configured with one of
pdcpBufferSizeThreshold: The configured PDCP SDU buffer 10 size threshold for detecting congestion, if the remaining SDUs/PDUs in the buffer exceeds this threshold, the UE considers that the XR RB/service is experiencing congestion.
pdcpBufferSizeThreshold: The configured threshold for maximum delay experienced by PDCP SDUs/PDUs in the buffer for detecting congestion, if the delay experienced by the SDUs/PDUs in the buffer exceeds this threshold, the UE considers that the XR RB/service is experiencing congestion.
numLegacyDiscardThreshold: The configured threshold for maximum number of legacy PDCP discards that can happen before the discardDetectionTimer expires. If the number of legacy discards crosses the configured threshold while discardDetectionTimer is running, the UE considers that the XR RB is experiencing congestion.
discardDetection Window: The timer window within which the PDCP calculates the number of legacy discard occurrences to determine if the congestion scenario occurred.

In an embodiment, when the relevant PDCP entity is suspended, the congestion configuration and/or congestion state and/or congestion timer are reset and/or released.

In an embodiment, when the UE (101) receives a RRCRelease message or RRCRelease with Suspendconfig message or is requested by upper layer for RRC connection release, the congestion configuration and/or congestion state and/or congestion timer are reset and/or released.

In an embodiment, upon initiation of the RRC connection resume procedure, the UE (101) resets and/or releases the congestion configuration and/or congestion state and/or congestion timer.

In an embodiment, upon initiation of the RRC re-establishment procedure, UE resets and/or releases the congestion configuration and/or congestion state and/or congestion timer.

In an embodiment, upon detecting radio link failure, UE (101) resets and/or releases the congestion configuration and/or congestion state and/or congestion timer.

FIG. 2 is a block diagram that illustrates a network apparatus for handling congestion while packet discarding for extended reality (XR), according to the embodiment as disclosed herein.

The network apparatus (201) comprises a suite of components, including a processor (203), an I/O interface (205), a memory (207), and a congestion manager (209). This device serves as a conduit for end-users to connect with communication networks and access various services. The network apparatus (201) can take on many forms, including but not limited to mobile phones, smartphones, tablets, laptops, television, connected cars and Internet of Things (IoT) devices. However, the components of the network apparatus (201) are not limited thereto. For example, the network apparatus (201) may include more or fewer components than those described above. In addition, the network apparatus (201) corresponds to the base station of the FIG. 7.

The processor (203) of the network apparatus (201) communicates with the memory (207), I/O interface (205), and the congestion manager (209), executing instructions stored in the memory (207) and performing various processes. It may consist of one or multiple processors, such as a general-purpose CPU, an AP, a GPU, a VPU, and/or an AI-dedicated NPU.

Further, the memory (207) of the network apparatus (201) includes storage locations to be addressable through the processor (203). The memory (207) can store at least one of a congestion manager information received from the network apparatus, at least one SDU or PDU of the at least one PDU Set, PSI value from upper layer of the UE (101). The memory (207) is not limited to a volatile memory and/or a non-volatile memory. Further, the memory (207) can include one or more computer-readable storage media. The memory (207) can include non-volatile storage elements. For example, nonvolatile storage elements can include magnetic hard discs, optical discs, floppy discs, flash memories, or forms of electrically programmable memories (EPROM) or electrically erasable and programmable (EEPROM) memories. The memory (207) can store the media streams such as audios stream, video streams, haptic feedbacks and the like.

The I/O interface (205) transmits the information between the memory (107) and external peripheral devices. The peripheral devices are the input-output devices associated with the network apparatus (205). The network apparatus (201) receives UE capability message from the UE (101) about an indication to support of PSI based SDU discard configuration messages to the UE (101). And also transmits the signaling message to configure the UE (101) with discard information for congestion handling through the I/O interface (205).

The congestion manager (209) of the network apparatus (201) communicates with the I/O interface (205) and memory (207) for handling congestion while packet discarding for extended reality (XR). The congestion manager (209) is an innovative hardware that is realized through the physical implementation of both analog and digital circuits, including logic gates, integrated circuits, microprocessors, microcontrollers, memory circuits, passive and active electronic components, as well as optical components.

The congestion manager (209) receives the UE capability message from the UE (101) about an indication to support of PSI based SDU discard. Further, the congestion manager (209) transmits the signaling message to configure the UE (101) with discard information for congestion handling. The discard information for congestion handling comprises an explicit congestion status or an implicit congestion status, a first discard timer for low importance, a second discard timer, and a PSI based SDU discard status for one or more Data Radio Bearers (DRBs). Further, the congestion manager (209) receives at least one SDU or at least one PDU of the at least one PDU Set from the UE (101).

In an embodiment, the network apparatus (201) configures the XR radio bearer with the first discardTimer for low importance through RRC signaling (e.g. RRC reconfiguration carries the RadioBearerConfig consisting of first discardTimer for low importance for a XR RB). Configuration for first discardTimer for low importance can be provided instead of second discardTimer configuration (used for per SDU discard) or in addition to second discardTimer configuration. In an embodiment, one or more values for first discardTimer for low importance and/or second discardTimer are configured for different values of the PSI for the PDU Sets. Configuration signaling may include a mapping between the values of the first discardTimer for low importance and/or second discardTimer and the PSI values.

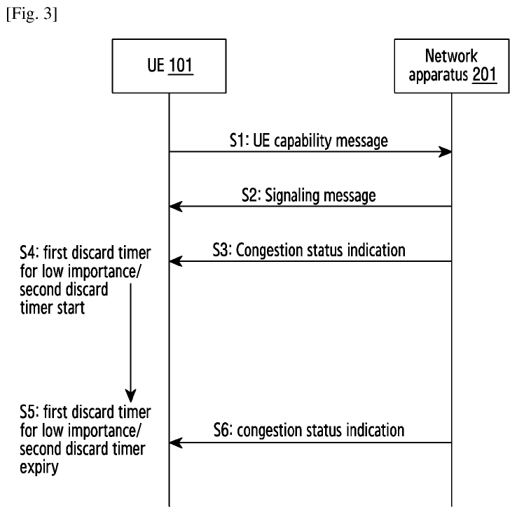

FIG. 3 is a sequence diagram that illustrates a process of handling congestion while packet discarding for extended reality (XR), according to the embodiment as disclosed herein.

At step S1, the UE (101) transmits UE capability message to the network apparatus (201) to indicate support for PSI based discard.

At step S2, the UE (101) receives a signaling message from the network apparatus (201) to be configured with discard information for congestion handling. The discard information for congestion handling comprises at least one of an implicit congestion status or an explicit congestion status, a first discard timer for low importance, a second discard timer and a PSI based SDU discard status of one or more Data Radio Bearers (DRBs).

At step S3, the UE (101) receives the congestion status to be at least one of activated or deactivated. The explicit congestion status can be received from the network apparatus (201) (e.g. A MAC CE indicating activation/deactivation of PSDI based SDU discard). Also, the implicit congestion status can be determined by the UE (101) itself.

At step S4, the UE (101) starts the first discard timer for low importance, when the explicit congestion status determines whether the PSI based SDU discard status of one or more DRBs is activated and the at least one SDUs, at least PDUs of the at least one PDU Set is associated with higher PSI value. In an embodiment, the UE (101) starts the second discard timer, when the at least one SDU or at least one PDU of the at least one PDU Set is associated with the lower PSI value.

At step S5, the UE (101) determines whether the first discard timer for low importance or the second discard timer is expired. The UE (101) discards the at least one SDU or the at least one PDU of the at least one PDU Set associated with higher PSI value, when the first discard timer for low importance expires. In an embodiment, UE (101) discards the at least one SDU or the at least one PDU of the at least one PDU Set associated with lower PSI value, when the second discard timer expires.

At step S6, the UE (101) receives an indication of the change in the congestion status from the network apparatus (201) (e.g. A MAC CE indicating activation/deactivation of PSDI based SDU discard). Further, the UE (101) discards the at least one SDU or the at least one PDU of the at least one PDU Set irrespective of the PSI value associated with the at least one PDU Set when the respective first discard timer for low importance (if were running) or second discard timer expires.

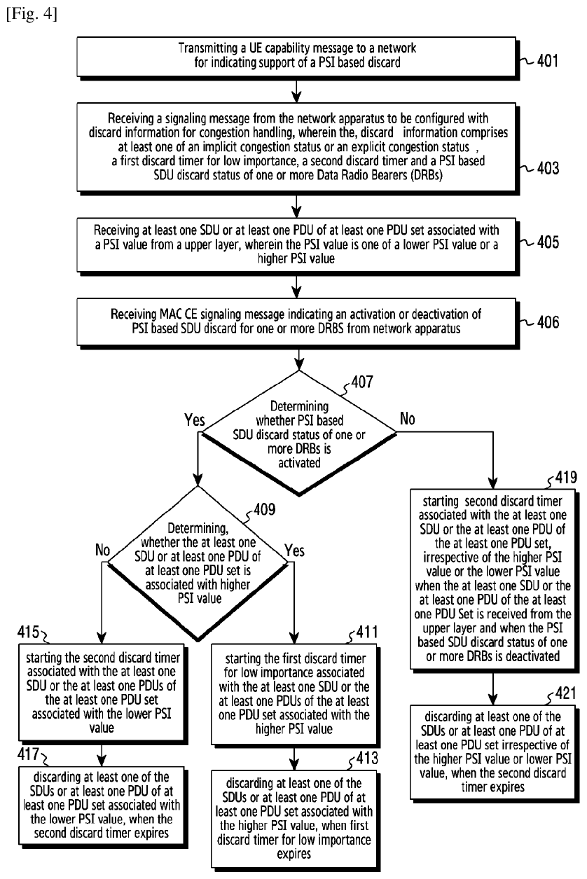

FIG. 4 is a flow diagram illustrating a method of handling congestion while packet discarding for extended reality (XR), according to the embodiment as disclosed herein.

At block 401, the UE (101) transmits a UE capability message to a network for indicating support of a PSI based discard.

At block 403, the UE (101) receives signaling message from the network apparatus to be configured with discard information for congestion handling. The discard information for congestion handling comprises a at least one of an implicit congestion status or an explicit congestion status, a first discard timer for low importance, a second discard timer and a PSI based SDU discard status of one or more Data Radio Bearers (DRBs).

At block 405, the UE (101) receives at least one SDU or at least one PDU of at least one PDU Set associated with a PSI value from an upper layer. The PSI value is one of a lower PSI value or a higher PSI value.

At block 406, the UE (101) receives the MAC CE signaling message indicating an activation or deactivation of PSI based SDU discard for one or more DRBs from network apparatus.

At block 407, the UE (101) determines whether the PSI based SDU discard status of one or more DRBs is activated.

At block 409, the UE (101) determines whether the received at least one SDU or at least one PDU of the at least one PDU Set is associated with higher PSI value.

At block 411, the UE (101) starts the first discard timer for low importance associated with the at least one SDU or the at least one PDU of the at least one PDU Set associated with the higher PSI value, when the at least one SDU or the at least one PDU of the at least one PDU Set is received from the upper layer, when the PSI based SDU discard status of the one or more DRBs is activated and the when the at least one SDU or at least one PDU of the at least one PDU Set is associated with higher PSI value.

At block 413, the UE (101) discards at least one SDU or at least one PDU of at least one PDU Set associated with the higher PSI value, when the PSI based SDU discard status of DRBs is activated, when the first discard timer for low importance expires.

At block 415, the UE (101) starts the second discard timer associated with the at least one SDU or the at least one PDU of the at least one PDU Set associated with the lower PSI value, when the at least one SDU or at least one PDU of at least one PDU Set is associated with lower PSI value.

At block 417, the UE (101) discards at least one SDU or at least one PDU of at least one PDU Set associated with the lower PSI value, when the second discard timer expires.

At block 419, the UE (101) starts second discard timer associated with the at least one SDU or the at least one PDU of the at least one PDU Set irrespective of the higher PSI value or the lower PSI value when the at least one SDU or the at least one PDU of the at least one PDU Set is received from the upper layer and when the PSI based SDU discard status of one or more DRBs is deactivated.

At block 421, the UE (101) discards at least one SDU or at least one PDU of at least one PDU Set irrespective of the higher PSI value or lower PSI value, when the second discard timer expires.

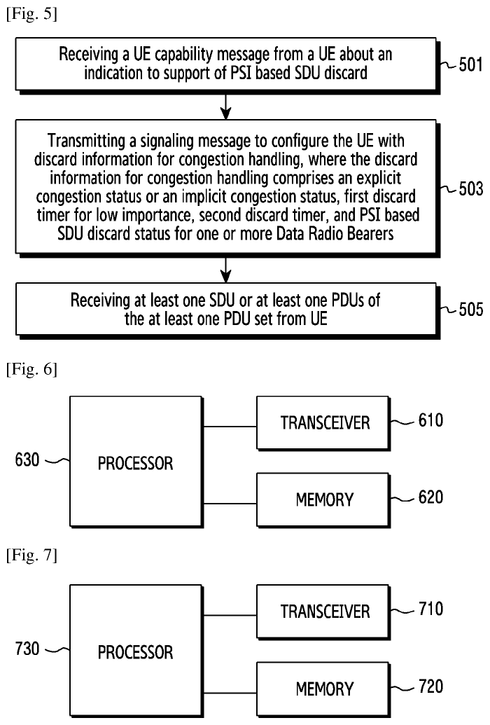

FIG. 5 is a flow diagram illustrating a method of handling congestion by network apparatus while packet discarding for extended reality (XR), according to the embodiment as disclosed herein.

At block 501, the network apparatus (201) receives a UE capability message from a UE about an indication to support of PSI based SDU discard.

At block 503, the network apparatus (201) transmits signaling message to configure the UE with discard information for congestion handling. The discard information for congestion handling comprises an explicit congestion status or an implicit congestion status, the first discard timer for low importance, the second discard timer, and the PSI based SDU discard status for one or more Data Radio Bearers (DRBs).

At block 505, the network apparatus (201) receives at least one SDU or at least one PDU of the at least one PDU Set from UE (101).

The proposed solution, the discloses a method for handling congestion while packet discarding for extended reality (XR). Further, the proposed solution enables an efficient approach for congestion handling and PSI based discard mechanism for XR. Further, the proposed solution enhances the UE and network performance for XR applications. The congestion handling helps to alleviate the scheduling burden for not important data. Also, the proposed solution ensures better resource scheduling for the more important data and thus enhancing the service performance and user experience.

FIG. 6 illustrates a structure of a UE according to an embodiment of the disclosure.

As shown in FIG. 6, the UE according to an embodiment may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor. Furthermore, the UE of FIG. 6 corresponds to the UE (101) of the FIG. 1.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for upconverting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

FIG. 7 illustrates a structure of a base station according to an embodiment of the disclosure.

As shown in FIG. 7, the base station according to an embodiment may include a transceiver 710, a memory 720, and a processor 730. The transceiver 710, the memory 720, and the processor 730 of the base station may operate according to a communication method of the base station described above. However, the components of the base station are not limited thereto. For example, the base station may include more or fewer components than those described above. In addition, the processor 730, the transceiver 710, and the memory 720 may be implemented as a single chip. Also, the processor 730 may include at least one processor. Furthermore, the base station of FIG. 7 corresponds to the network apparatus (201) of the FIG. 2.

The transceiver 710 collectively refers to a base station receiver and a base station transmitter, and may transmit/receive a signal to/from a terminal (UE) or a network entity. The signal transmitted or received to or from the terminal or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the base station. Also, the memory 720 may store control information or data included in a signal obtained by the base station. The memory 720 may be a storage medium, such as read-only memory (ROM), random access memory (RAM), a hard disk, a CDROM, and a DVD, or a combination of storage media.

The processor 730 may control a series of processes such that the base station operates as described above. For example, the transceiver 710 may receive a data signal including a control signal transmitted by the terminal, and the processor 730 may determine a result of receiving the control signal and the data signal transmitted by the terminal. Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a user equipment (UE) in a wireless communication system, the method comprising:
receiving, from a base station, configuration information on a discard timer associated with a protocol data unit (PDU) set importance (PSI);
receiving, from the base station, information indicating whether a PSI based service data unit (SDU) discard is activated; and
performing the PSI based SDU discard for a packet-data convergence protocol (PDCP) SDU based on the configuration information in case that the PSI based SDU discard is activated.

2. The method of claim 1,
wherein the discard timer is started upon reception of an SDU with low importance.

3. The method of claim 1,
wherein the information is included in medium access control (MAC) control element (CE), and
wherein one bit in the MAC CE indicates whether the PSI based SDU discard is activated per data radio bearer (DRB).

4. The method of claim 1,
wherein, in case that the PSI based SDU discard is configured for a PDU set, the PSI based SDU discard applies to PDCP SDUs belonging to the PDU set, and
wherein, in case that the PSI based SDU discard is not configured for the PDU set, the PSI based SDU discard applies to one PDCP SDU associated with the discard timer.

5. A method performed by a base station in a wireless communication system, the method comprising:
transmitting, to a user equipment (UE) configuration information on a discard timer associated with a protocol data unit (PDU) set importance (PSI); and
transmitting, to the UE, information for-indicating whether a PSI based service data unit (SDU) discard is activated,
wherein the PSI based SDU discard for a packet-data convergence protocol (PDCP) SDU is based on the configuration information.

6. The method of claim 5,
wherein the discard timer is based on reception of an SDU with low importance.

7. The method of claim 5,
wherein the information is included in medium access control (MAC) control element (CE), and
wherein one bit in the MAC CE indicates whether the PSI based SDU discard is activated per data radio bearer (DRB).

8. The method of claim 5,
wherein, in case that the PSI based SDU discard is configured for a PDU set, the PSI based SDU discard applies to PDCP SDUs belonging to the PDU set, and
wherein, in case that the PSI based SDU discard is not configured for the PDU set, the PSI based SDU discard applies to one PDCP SDU associated with the discard timer.

9. A user equipment (UE) comprising:
at least one transceiver;
at least one controller communicatively coupled to the at least one transceiver; and
at least one memory, communicatively coupled to the at least one controller, storing instructions executable by the at least one controller individually or in any combination to cause the UE to:
receive, from a base station, configuration information on a discard timer associated with a protocol data unit (PDU) set importance (PSI),
receive, from the base station, information indicating whether a PSI based service data unit (SDU) discard is activated, and
perform the PSI based SDU discard for a packet-data convergence protocol (PDCP) SDU based on the configuration information in case that the PSI based SDU discard is activated.

10. The UE of claim 9,
wherein the discard timer is started upon reception of an SDU with low importance.

11. The UE of claim 9,
wherein the information is included in medium access control (MAC) control element (CE), and
wherein one bit in the MAC CE indicates whether the PSI based SDU discard is activated per data radio bearer (DRB).

12. The UE of claim 9,
wherein, in case that the PSI based SDU discard is configured for a PDU set, the PSI based SDU discard applies to PDCP SDUs belonging to the PDU set, and
wherein, in case that the PSI based SDU discard is not configured for the PDU set, the PSI based SDU discard applies to one PDCP SDU associated with the discard timer.

13. A base station comprising:
at least one transceiver;
at least one controller communicatively coupled to the at least one transceiver; and
at least one memory, communicatively coupled to the at least one controller, storing instructions executable by the at least one controller individually or in any combination to cause the base station to:
transmit, to a user equipment (UE) configuration information on a discard timer associated with a protocol data unit (PDU) set importance (PSI), and
transmit, to the UE, information indicating whether a PSI based service data unit (SDU) discard is activated,
wherein the PSI based SDU discard for a packet-data convergence protocol (PDCP) SDU is based on the configuration information.

14. The base station of claim 13,
wherein the discard timer is based on reception of an SDU with low importance.

15. The base station of claim 13,
wherein the information is included in medium access control (MAC) control element (CE), and
wherein one bit in the MAC CE indicates whether the PSI based SDU discard is activated per data radio bearer (DRB).
